(19) United States
(12) Patent Application Publication
(10) Pub. No.: US 2011/0136396 A1
(43) Pub. Date: Jun. 9, 2011

(54) Re-enterable end cap

(76) Inventors: Douglas Neil Burwell, Georgetown (CA); Maziar Hadian, Brampton (CA); Vinodrai Lad, Mississauga (CA); Sharon Elizabeth Krawiec, Mississauga (CA)

(21) Appl. No.: 12/592,804

(22) Filed: Dec. 3, 2009

(51) Int. Cl. H01R 13/40

(52) U.S. Cl. 439/750

(57) ABSTRACT

A re-enterable end cap for sealing and protecting an end of an exposed cable conductor while allowing repeated access to the cable by a metal test probe. The end cap has an outer tubular shell which is open at one end to receive the end of the cable and closed at the opposite end by a plug of rigid material. The tubular shell may be dimensionally recoverable. The plug has a hollow cavity which contains a deformable self-sealing material. Access to the interior of the end cap is provided through an aperture in an end wall of the plug. The hollow interior of the plug may be provided with a one-way valve member which permits the test probe to enter the plug while preventing excessive loss of the self-sealing material through the aperture in the end wall. The valve member may take the form of a ball having a diameter which is greater than the diameter of the aperture and which is embedded in the self-sealing material. A similar construction may be incorporated into a test terminal to be applied to the side of a cable.

### FIELD OF THE INVENTON

The invention relates to end caps for sealing and protecting the ends of exposed cable conductors, and more specifically to end caps which permit a test probe to access the enclosed conductors.

### BACKGROUND OF THE INVENTION

In urban areas, stray voltage from underground power cables is known to cause death and injury to pedestrians and pets. Stray voltage may be caused by voltage leaks from underground cables with damaged or degraded insulation. The damaged or degraded cables can energize surface-level structures such as manhole covers, curbs, lampposts, etc., often with the assistance of water from rain or snow.

Standard practice in power distribution grids in urban areas is to have an underground power cable run into a manhole where the power is fed to two or more cables by the use of a joint (commonly called a crab joint). In other words, the incoming power cable feeds a number of outgoing power cables. Commonly, one or more of the outgoing power cables are not needed and therefore are terminated by the use of an end cap.

During maintenance procedures it is often necessary to test underground cables to determine whether or not they are energized, i.e. whether they are “live” or “dead”. To test a cable, a technician commonly takes a terminated cable and punches a blunt metal probe through the cable jacket to contact the underlying conductor. Once the probe is removed, the hole in the insulation may be sealed improperly or not at all, thereby making the conductor more prone to voltage leaks.

An end cap for an underground power cable can be made by molding a tubular member which is open at one end. An effective and economical end cap construction is disclosed by U.S. Pat. No. 5,439,031 (Steele et al.). The Steele et al. end cap comprises a heat-shrinkable tube having one end closed by heat recovering the end of the tube over a dimensionally stable, solid plug. The open end of the cap may be internally coated with adhesive to provide an air and water-tight seal when the cap is heat recovered over the end of a cable.

Re-enterable end caps are also known. These end caps have resealable closures which can be repeatedly penetrated by test probes while maintaining a seal over the end of the cable, and therefore allow testing of cable conductors without perforating the cable jacket. U.S. Pat. No. 4,504,699 (Dones et al.) discloses examples of re-enterable end caps. According to a first end cap design shown in FIGS. 1 and 2 of Dones et al., one end of the end cap is provided with a plug of deformable self-sealing material which can be penetrated by a test probe and will continue to seal the end cap after the probe is removed. However, the self-sealing material lacks the strength and integrity required for end caps. In an alternate construction shown in FIG. 3 of Dones et al. the self-sealing material is contained in a chamber enclosed by the end cap sleeve and a metal plate which is in electrical communication with the conductors through a solder fillet. In this alternate construction, however, the test probe does not come directly into contact with the conductor, resulting in an increased chance of false readings. The alternate construction of Dones et al. is also relatively expensive to manufacture, as compared to Steele et al., due at least partly to the need for an end cap sleeve which is closed at one end.

Therefore, there is a need for improved re-enterable end caps for protection and testing of electrical conductors.

### SUMMARY OF THE INVENTION

In one aspect, the present invention provides a resealable test cap, comprising: (a) an outer tubular shell having a first end and a second end, wherein the first end is open; (b) a plug of rigid material closing the second end of the outer shell, wherein the plug has a side wall and a first end wall defining a hollow interior cavity, wherein the first end wall has an aperture extending therethrough to permit access to the interior cavity through the first end wall; and (c) a deformable self-sealing material located inside the interior cavity and sealing the aperture.

In another aspect, the aperture in the first end wall has a diameter which is less than a maximum diameter of the interior cavity.

In another aspect, the side wall has a substantially cylindrical outer surface which is sealed to an inner surface of the outer tubular shell.

In another aspect, the outer surface of the side wall of the plug is provided with one or more circumferentially extending corrugations.

In yet another aspect, the outer tubular shell is dimensionally recoverable.

In yet another aspect, the second end of the outer tubular shell is dimensionally recovered so as to seal against an outer surface of the side wall of the plug, and the second end of the outer tubular shell has a smaller diameter than the first end of the outer tubular shell.

In yet another aspect, the rigid plug is comprised of a puncture-resistant polymeric material.

In yet another aspect, the first end wall has an outer surface in communication with a surrounding environment of the resealable test cap, and the outer surface of the first end wall comprises an inverted, conical surface with the aperture located at its apex, such that the outer surface of the first end wall forms a guide surface to assist a probe in entering the aperture.

In yet another aspect, the plug of rigid material further comprises a second end wall located in opposed relation to the first end wall, and the second end wall has an aperture extending therethrough to permit access to the interior cavity through the second end wall.

In yet another aspect, the first end wall has a one-way valve member located inside the cavity, and the valve member has a closed configuration in which it is located in blocking relation to the aperture in the first end wall.

In yet another aspect, the one-way valve member is displaceable by an object inserted through the aperture into the interior cavity. The valve may comprise a flap or a ball. Where the valve comprises a ball it has a diameter greater than a diameter of the aperture and may be embedded in the self-sealing material.

In yet another aspect, the first end wall has an inner surface defining an end surface of the interior cavity, and the inner surface is in the form of a cone having a base located at the plug side wall and with the aperture located at the apex of the conical surface.

In yet another aspect, the plug is comprised of two dish-shaped sections having peripheral flanges along which they are joined together in face-to-face relation. The two dish-shaped sections making up the plug may be substantially identical mirror images of one another.

In another aspect, the invention provides a resealable test terminal, comprising: (a) an outer tubular sleeve having a first end and a second end, wherein the first end is open; (b) a plug of rigid material closing the second end of the outer shell, wherein the plug has a side wall and a first end wall defining a hollow interior cavity, wherein the first end wall has an aperture extending therethrough to permit access to the interior cavity through the first end wall; (c) a deformable self-sealing material located inside the interior cavity and sealing the aperture; and (d) a flexible flange extending radially outwardly of the first end of the sleeve.

### BRIEF DESCRIPTION OF THE DRAWINGS

The invention will now be described, by way of example only, with reference to the accompanying drawings in which:

FIG. 1 is a perspective view of a re-enterable end cap according to a first embodiment of the invention;

FIG. 2 is a longitudinal cross section along line 2-2 of FIG. 1;

FIG. 3 is a partial longitudinal cross-section through the re-enterable end cap of FIG. 1, which has been enlarged to show details of the resealable plug;

FIG. 4 is a longitudinal cross section, similar to FIG. 2, showing the re-enterable end cap of FIG. 1 before it has been recovered over the end of an electrical cable;

FIG. 5 is a longitudinal cross section similar to that of FIG. 4, showing the re-enterable end cap of FIG. 1 after it has been recovered over the end of an electrical cable;

FIG. 6 is a longitudinal cross section similar to that of FIG. 5, showing a test probe inserted through the resealable plug and contacting the cable conductor;

FIG. 7 is a longitudinal cross section showing a re-enterable test cap according to another embodiment of the invention;

FIG. 8 is a longitudinal cross section similar to that of FIG. 4 except with a test probe extending through the resealable plug;

FIG. 9 is a longitudinal cross section through a re-enterable test cap according to yet another embodiment of the invention; and

FIG. 10 is a perspective view of a re-enterable test terminal according to yet another embodiment of the invention.

### DETAILED DESCRIPTION

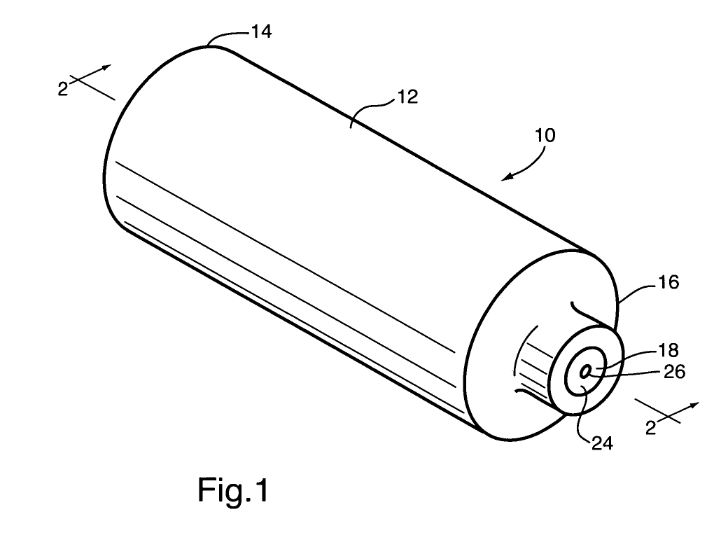

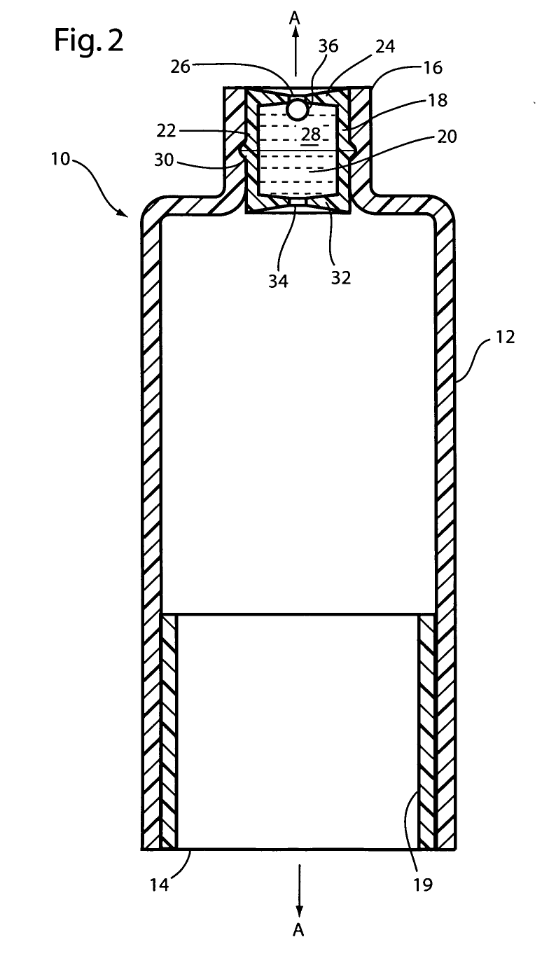

FIGS. 1 to 3 illustrate a finished, unrecovered re-enterable end cap 10 according to an embodiment of the invention. The end cap 10 comprises an outer tubular shell 12 which may be dimensionally recoverable. The shell 12 has a first end 14 which is open and an opposite second end 16 which is closed by a plug 18 of rigid material. As shown in FIG. 2, the inner surface of shell 12 may be partially coated with a layer 19 of adhesive material, at least near the first end 14, for reasons which will become apparent below. The end cap 10 has a hollow interior which defines an enclosure for the end of an electrical cable.

Where the outer tubular shell 12 is dimensionally recoverable, it may be either cold-shrinkable or heat-shrinkable, such that it can be slipped over the end of a cable and heated or cooled to cause it to shrink radially into intimate contact with the cable jacket. Where the shell 12 is cold-shrinkable or heat-shrinkable it may be made of any material that is capable of exhibiting the property of elastic memory after stretching or expansion to a heat unstable dimensional state, whether crosslinked or uncrosslinked. For example, where the shell 12 is heat shrinkable, it may be made from any of the materials mentioned by Steele et al. (U.S. Pat. No. 5,439,031) as being suitable for use in heat shrinkable tubular members. Suitable materials for forming the heat shrinkable shell 12 include crosslinked polyethylene or crosslinked polyethylene copolymers such as ethylene vinyl acetate, ethylene methyl acrylate, ethylene ethyl acrylate, ethylene-propylene, ethylene-propylene-diene, and ethylene-vinyl-silane. Further examples of polymeric materials that may be used in crosslinked form include mechanical or reactive blends of polyethylene, polyethylene copolymers or polypropylene with non-crosslinked or partially crosslinked elastomers, such as those based on ethylene-propylene, nitrile, styrene-butadiene, isoprene and chlorinated elastomers, such materials being generically termed thermoplastic elastomers, thermoplastic vulcanizates or melt processible rubbers. Further examples include curable elastomers based on ethylene-propylene, silicone, isobutylene, butadiene, chloroprene, and chlorinated polyethylene.

Where the outer tubular shell 12 is cold-shrinkable, it may be comprised of silicone or an ethylene propylene diene monomer (EPDM) rubber.

Although the specific embodiments of end caps described herein have dimensionally recoverable outer shells, this is not necessarily the case. Rather, it will be appreciated that the end cap according to the invention can be provided with a non-dimensionally recoverable outer shell which slips over and forms a close fit with the cable jacket. In this case, the jacket may be made of a material such as ethylene-propylene rubber (EPR) or thermoplastic rubber (TPR).

Any or all of the above materials for the outer tubular shell 12 may be used in the form of filled or unfilled compositions. Filled compositions may contain additives such as antioxidants; stabilisers; inorganic mineral fillers, including conductive fillers and reinforcing fibres; inorganic or organic flame retardants; crosslinking promoters or accelerators; processing aids; and pigments, at a typical loading of about 1 to about 75% by weight of the total composition. In one example where the shell is heat-shrinkable, it comprises a crosslinked blend of polyethylene and polyethylene copolymer containing typically 30 to 50% by weight of said additives.

The adhesive layer 19 may comprise any of the adhesives, sealants, mastics or other bonding agents disclosed by Steele et al. (U.S. Pat. No. 5,439,031). The adhesive layer 19 may cover the entire length of the outer tubular shell 12 except for the second end 16 which may be purposely left uncoated to accommodate a weldable plug 18. Alternatively, the adhesive layer 19 may comprise a continuous, co-extruded inner layer of outer tubular shell 12 which remains fusible on dimensional recovery of the shell 12 over the plug 18. Alternatively, the outer tubular shell 12 may be selectively crosslinked in the outer portion of its wall so that its inner surface remains relatively meltable and will bond adhesively when hot to the plug 18. Where the adhesive layer 19 comprises an internal coating, it may comprise a thermoplastic hot melt adhesive or sealant extending from about 10-50% of the length of the outer tubular shell 12, measured from the open first end 14.

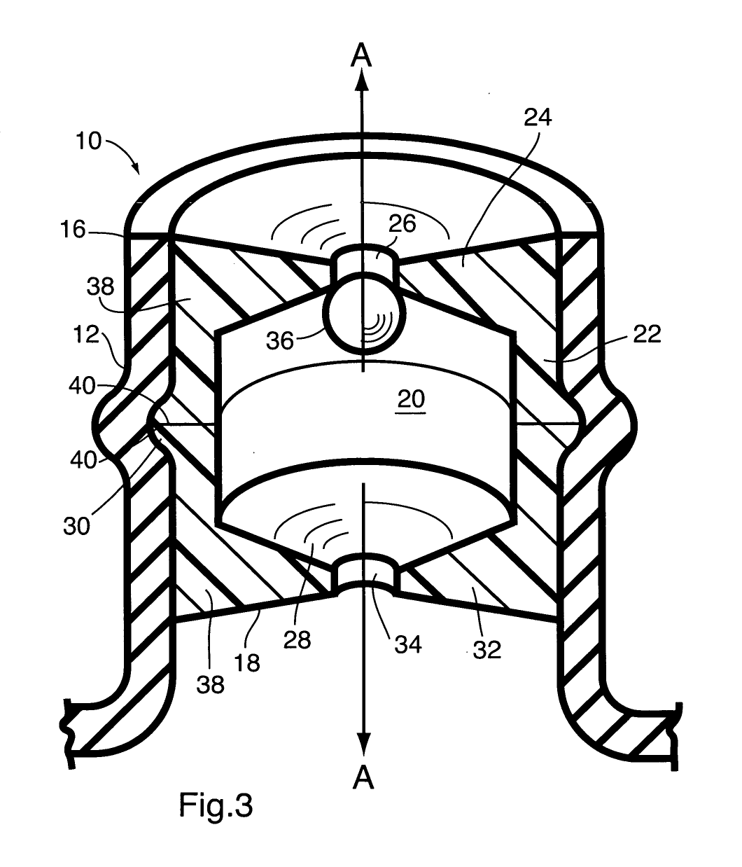

As shown in the enlarged cross section of FIG. 3, the plug 18 is hollow and has an interior cavity 20 which is defined at least by a side wall 22 and a first end wall 24. Although the plug 18 is shown as having a substantially cylindrical side wall 22, this is at least partly due to the fact that the outer shell 12 is in the form of a cylindrical section of tube. It will be appreciated that the side wall 22 of plug 18 is not necessarily cylindrical, but rather may be of any shape which permits the plug 18 to form a seal with the outer tubular shell 12. Other functional shapes include angular shapes such as square, hexagonal or octagonal; conical, serrated or fluted. The first end wall 24 forms a barrier between the interior cavity 20 and the surrounding environment external to the end cap 10. The first end wall 24 is provided with an aperture 26 which extends through the first end wall 24 so that the interior cavity 20 can be accessed by the end of a test probe.

The interior cavity 20 is at least partially filled with a deformable, self-sealing material 28, such as a polymeric gel, which can be penetrated by the probe, but which automatically restores a water-tight seal once the probe is withdrawn from the end cap 10. Therefore, the self-sealing material 28 is effective to prevent entry of water or other foreign matter from the surrounding environment into the interior of end cap 10. The self-sealing material 28 may comprise any elastomeric gel compound exhibiting a self sealing or healing characteristic when the gel is temporarily penetrated by a probe or other foreign object. Examples of such materials include diorganopolysiloxane having a viscosity at 25° C. of 50 to 100,000 mPas (centipoise); thermoplastic elastomer gels such as block copolymers (styrenics, copolyesters, polyurethanes and polyamides); thermoplastic/elastomer blends and alloys (thermoplastic polyolefins and thermoplastic vulcanizates); visco-elastic compounds based on mineral oils; polybutene; polyisobutylene; butyls; and petrolatum.

The plug 18 is securely attached to the outer tubular shell 12 at the second end 16 thereof. In the embodiment shown in the drawings, the side surface 22 is sealed to the inner surface of the outer tubular shell 12 at the second end 16. The securement of plug 18 within the second end 16 of shell 12 is sufficiently strong so as to prevent the plug 18 from being dislodged from the end cap 10 during use, and to maintain a water-tight seal between the plug 18 and shell 12. An effective seal may be provided by heat-welding the side wall 22 of plug 18 directly to the inner surface of shell 12. For example, where the outer tubular shell 12 is heat-shrinkable, the second end 16 of the shell 12 may be recovered around the plug 18, with sufficient heat being applied to weld the plug 18 and the shell 12 together. The weld between plug 18 and shell 12 may comprise a “fusion bond” in which the surfaces of the plug 18 and shell 12 merge or fuse together.

To assist in retaining the plug 18 inside the second end 16 of shell 12, the outer surface of side wall 22 may be provided with one or more radial projections such as ribs or corrugations in order to provide a mechanical connection between the plug 18 and the shell 12. In this regard, plug 18 shown in the drawings has an annular, radially-projecting rib 30 around which the second end 16 of outer shell 12 is dimensionally recovered. Although end cap 10 is shown in the drawings as having a radially-projecting rib 30, it will be appreciated that a strong, water-tight seal between the plug 18 and shell 12 may be provided in the absence of any mechanical elements, for example where a fusion bond is formed between the plug 18 and the shell 12.

The plug 18 may further comprise a second end wall 32 located in opposed relation to the first end wall 24. The second end wall 32 forms a barrier between the interior cavity 20 and the interior of the end cap 10 in which the end of the cable is to be received. The second end wall 32 has an aperture 34 extending therethrough in order to permit a probe to extend through the interior cavity 20 and into the interior of end cap 10. Furthermore, the apertures 26 and 34 in respective end walls 24, 32 are aligned along a central longitudinal axis A extending through the end cap 10, such that a probe inserted into plug 18 along the axis will penetrate through both apertures 26, 34, and thereby penetrate through the plug 18 into the interior of the end cap 10. The apertures 26, 34 may be of the same or similar diameter, as shown in the drawings. This is not necessary, however. Rather, the aperture 34 may be of greater diameter than aperture 26, and in some embodiments of the invention, described below, the second end wall 32 can be eliminated entirely.

The plug 18 is comprised of a polymeric material which is resistant to temperatures encountered during manufacturing and use of the end cap 10, and which is sufficiently rigid such that it resists being damaged by a test probe, i.e. such that the plug 18 resists being punctured except through the aperture 26. Making the plug puncture resistant ensures that the test probe can only penetrate through the plug 18 by passing through apertures 26, 34 and the self-sealing material 28 contained within the interior cavity 20. This ensures that the plug 18 will not be damaged by an errant probe. The plug 18 may comprise any of the plug materials mentioned by Steele et al. (U.S. Pat. No. 5,439,031). For example, the plug 18 may be of identical or different composition to the outer tubular shell 12, and may for example comprise a blend of polyethylene and polyethylene copolymer in an uncrosslinked or crosslinked state. The plug 18 may be coextruded with an outer layer of adhesive or a material selectively crosslinked to be relatively meltable and to bond adhesively when hot to the inner surface of the shell 12. The plug may also be provided with an additive which renders the plug luminescent, so that the plug 18 can easily be located under poor lighting conditions.

The end wall 24 may be shaped so as to help guide the probe through the aperture 26 in the first end wall 24. In end cap 10, the outer surface of first end wall 24 has a conical shape, with the aperture 26 being centrally located at the apex of the cone, with the apex being directed inwardly toward the interior cavity 20. With this configuration, a probe striking anywhere on the outer surface of first end wall 24 will tend to be guided toward the aperture 26.

Similarly, where the plug 18 includes a second end wall 32, the end wall 32 may be shaped to help guide the probe through the aperture 34. In end cap 10, the inner surface of the second end wall 32 has a conical shape, with the aperture 34 being centrally located at the apex of the cone, and with the apex being directed outwardly of the interior cavity 20, toward the interior of end cap 10. Therefore, a probe striking the inner surface of the second end wall 32 will tend to be guided toward the aperture 34.

When an electrical current flows through a cable, the current-carrying conductors become heated and any air which is trapped within the cable jacket expands and becomes pressurized. When the ends of the cable are sealed by an end cap such as cap 10 illustrated in the drawings, the internal air pressure within the cable tends to push outwardly against the rigid plug 18 at the second end 16 of shell 12. When this pressure is exerted against the self-sealing material 28 contained within interior cavity 20, it may force some of the self-sealing material 28 out of the plug 18 through aperture 26. In order to prevent excessive loss of material 28, the aperture 26 may be of small diameter relative to the maximum diameter of the interior cavity 20, for example the ratio of the diameter of the interior cavity to the diameter of the aperture 26 may be in the range from about 3 to 6. Furthermore, the aperture has a diameter which may be about the same or slightly smaller than the diameter of a test probe. For example, where the test probe has a diameter of 2.5 millimeters, the aperture 26 may have a diameter of from about 1.5 to 3 millimeters, for example about 2.0 to 2.5 millimeters.

To further prevent loss of self-sealing material 28 through aperture 26, and to further ensure a water tight seal, the first end wall 26 may be provided with a one-way valve member so as to block the aperture 26 and thereby prevent the sealing material 28 from being pushed out through the aperture 26, while permitting a test probe to penetrate the interior of test cap 10 through aperture 26.

Various constructions of the one-way valve member are possible. For example, in the end cap 10 shown in the drawings, the one-way valve member comprises a ball 36 having a diameter greater than that of the aperture 26, which is embedded in the self-sealing material 28. The ball 36 is located in close proximity to the aperture 26 in the first end wall 24, and may be located in blocking relation to the aperture 26. The ball 36 may be comprised of a rigid polymeric material and may, for example, be formed from the same polymeric material as the plug 18.

When a test probe penetrates the plug 18, the ball 36 is displaced away from the aperture 26 to allow the test probe to pass through the plug 18. Once the test probe is removed, the ball 36 will tend to spring back to its original position due to the resilient nature of the self-sealing material 28 in which it is embedded. Also, any pressurized gases within the test cap 10 will tend to push the ball 36 toward the aperture 26 in the first end wall 24, thereby blocking the aperture 26 and preventing excessive loss of the self-sealing material 28.

To assist the ball 36 in maintaining its blocking position relative to aperture 26, and to assist the ball 36 in returning to this position once it is displaced, the inner surface of the first end wall 24 may be shaped so as to guide the ball 36 toward the aperture 26. For example, the inner surface of first end wall 24 may be in the form of an outwardly-facing cone with the aperture 26 located at its apex, i.e. the apex of the cone faces away from the interior cavity 20, toward the exterior of end cap 10. Thus, as the ball 36 is acted on by pressure within the cable, it will be guided into blocking relationship to the aperture 26.

The plug 18 shown in the drawings may conveniently be manufactured from two identical, mating sections 38. The mating sections 38 each have annular flanges 40 along which the sections 38 are joined together. As shown, the flanges 40 may extend radially outwardly of the sidewall of plug 18 and cooperate to form rib 30. During manufacture of the plug 18, the ball 36 is inserted into the interior cavity 20 before the sections 28 are joined, and may be placed into blocking relationship with the aperture which will become aperture 26 in the finished plug. The two sections 38 are then joined together by any suitable means, such as by an adhesive, and the sealing material 28 is then injected into the cavity 20 after assembly of the sections 38. Using this method of manufacture ensures that the ball 36 is properly located when the end cap 10 is first installed on a cable. It will be appreciated that the mating sections 38 may be joined by alternate means, for example the sections 38 may be provided with interlocking elements which provide a snap-lock or similar mechanical connection, either with or without the assistance of an adhesive. In the plug 18 shown in the drawings, the mating sections 38 are identical, mirror images of one another in order to simplify construction and reduce manufacturing cost.

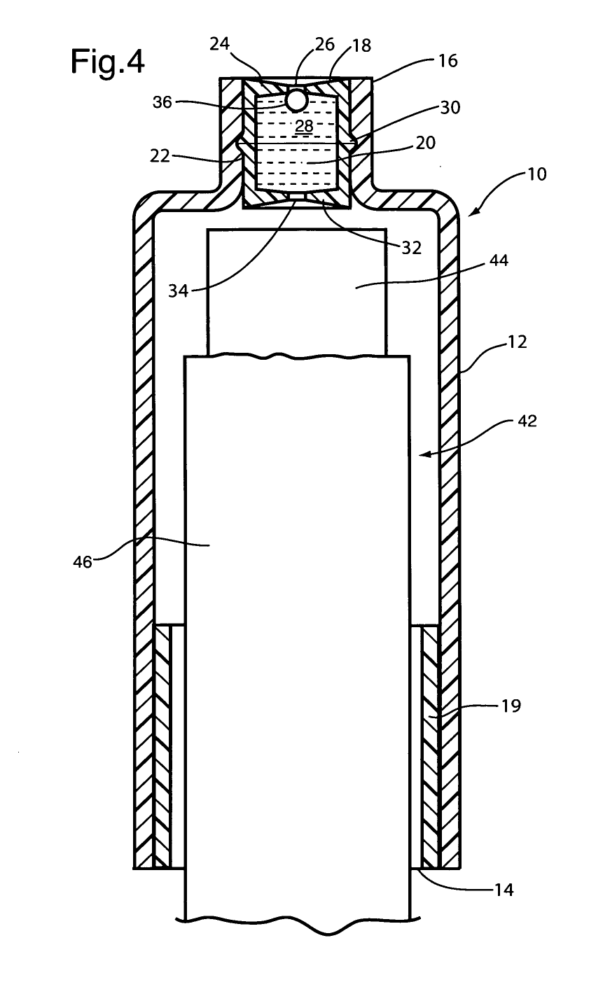

The installation and use of end cap 10 is now described below with reference to FIGS. 4 to 6. The end cap 10 described below has a dimensionally recoverable shell 12. FIG. 4 shows the finished, unrecovered re-enterable end cap 10 with an end of an electrical cable 42 loosely inserted into the first end 14 thereof. The electrical cable comprises a conductor 44, which may be a stranded or solid copper wire, and an insulating polymeric jacket 46 surrounding the conductor 44. The jacket 46 may be removed near the end of the cable 42 so as to expose the metal conductor 44, but the length of the exposed conductor 44 must be less than that of end cap 10 to ensure that the sleeve 12 of end cap 10 overlaps the cable jacket 46 by a sufficient amount to form a secure watertight seal between shell 12 and the jacket 46. The end of cable 42 is inserted into the end cap 10 such that the first end 14 of the end cap 10 overlaps the cable jacket 46 and with the conductor in proximity to the plug 18.

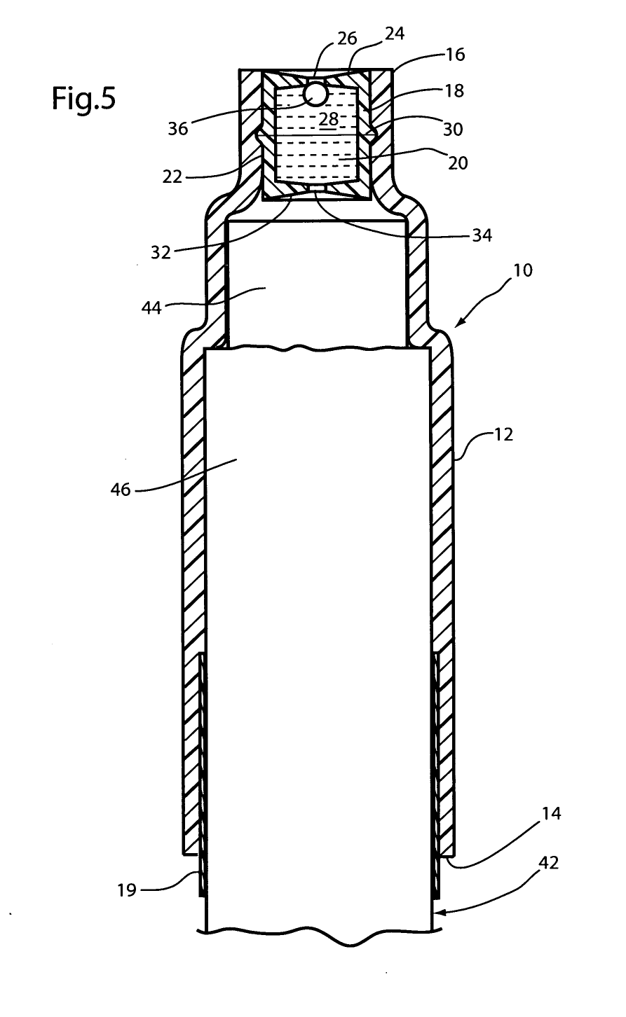

With the end of cable 42 loosely received inside the end cap 10 as shown in FIG. 4, the outer tubular shell 12 is then recovered so as to reduce its diameter and to bring the inner surface of the outer tubular shell 12 into intimate contact with the cable 42, as shown in FIG. 5. Where the shell 12 is heat-shrinkable, recovery is brought about by heating the shell 12 by any suitable means, such as by a heat gun or a torch. The shell 12 then becomes sealed to the cable jacket 46 by the layer 19 of adhesive or, where layer 19 is not provided, by direct bonding of the shell 12 to the cable jacket 46.

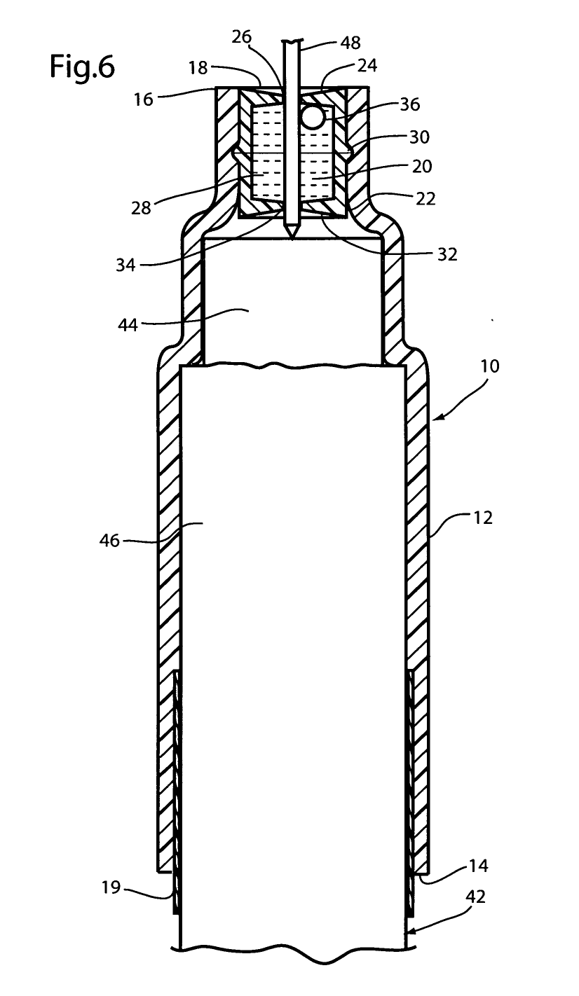

FIG. 6 is identical to FIG. 5 except that it shows the end of an elongate, conductive metal test probe 48 which has penetrated through the plug 18 from the exterior, with the tip of probe 48 penetrating the interior of the end cap 10 and coming into direct electrical contact with the conductor. With the probe 48 in this position, the cable 42 can be tested to determine whether it is live or dead. As can be seen from FIG. 6, the test probe 48 displaces the ball 36 to the side of aperture 26 as it enters the end cap 10. Also, it can be seen from FIG. 6 that the diameter of aperture 26 is such that the test probe 48 is closely received within the aperture 26. It can also be seen that the self-sealing material 28 is in contact with the test probe 48 and maintains its water-tight seal during testing.

Once the test probe 48 is withdrawn from the end cap 10, the self-sealing material 28 will seal any opening created by the probe 48, and the resilience of the self-sealing material 28 will cause the embedded ball 36 to spring back to its original position, i.e. blocking the aperture 26, or in close proximity thereto. As mentioned earlier, any pressure build-up within the cable 42 will also tend to push the ball 36 back to its original position illustrated in FIG. 4.

Since the performance of the end caps according to the invention can be enhanced by the presence of gas pressure within the cable, they are suitable for use with telecommunications cables, which may be gas-filled and pressurized to provide a positive pressure to maintain a moisture-free condition within the cable.

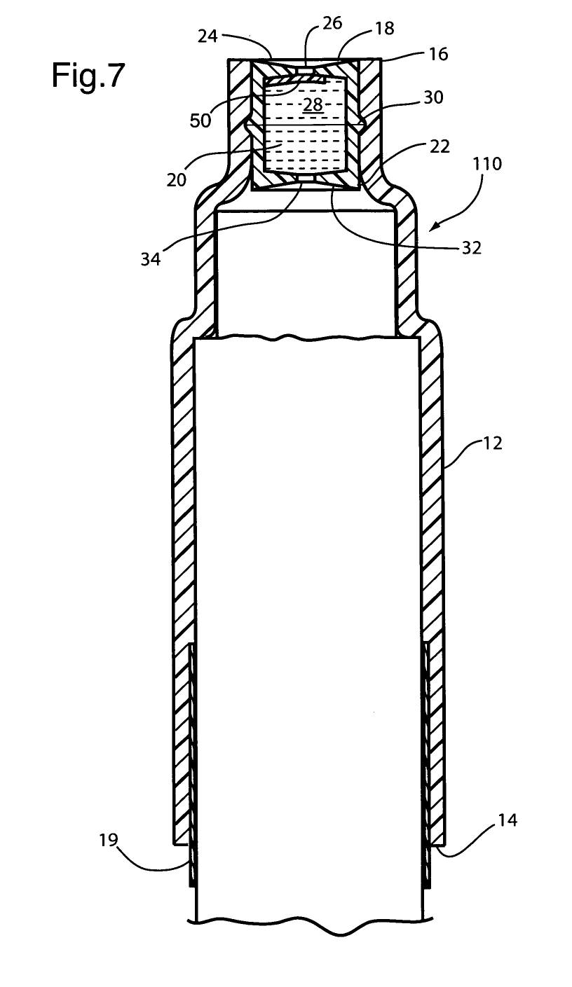

A number of variations may be made to the end cap without departing from the scope of the present invention. Some of the variants within the scope of the invention are shown in FIGS. 7 to 10 and are now discussed below. The alternate embodiments described below are similar to the end cap 10 described above, and therefore like elements of the alternate embodiments are identified by like reference numerals and, unless otherwise indicated, the above descriptions of these elements apply equally in the case of the alternate embodiments described below.

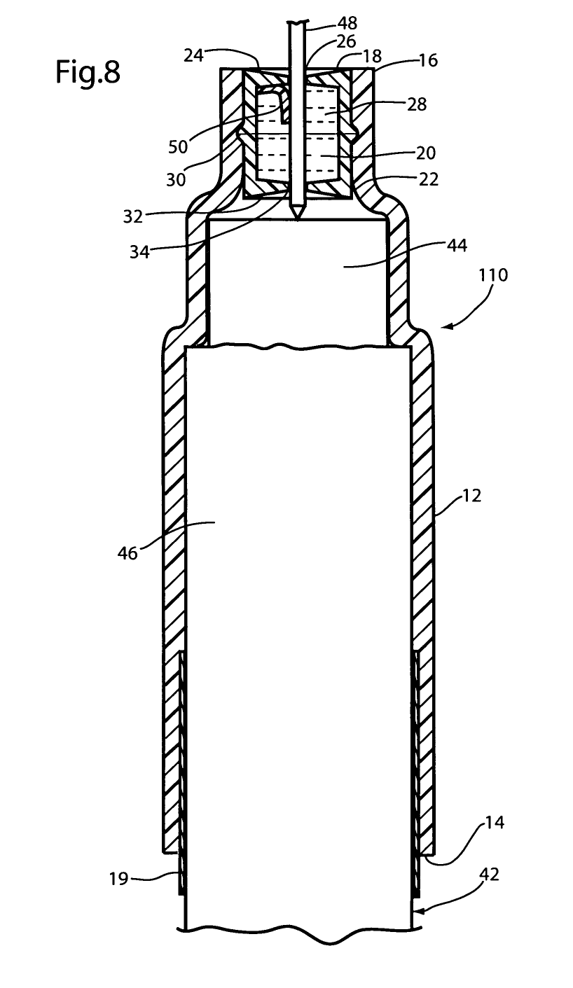

The end cap 10 described above includes a one-way valve member in the form of ball 36. It will be appreciated, however, that end caps according to the invention may employ other types of one-way valve members. For example, FIGS. 7 and 8 illustrate an end cap 110 according to an alternate embodiment of the invention, which is identical to end cap 10 described above in all respects except that the ball 36 is replaced by a flap 50 which may be attached to the inner surface of first end wall 24 and covers the aperture 26. As shown in FIG. 8, the flap 50 is pushed out of blocking relation with aperture 26 when a test probe 48 is inserted through the aperture 26.

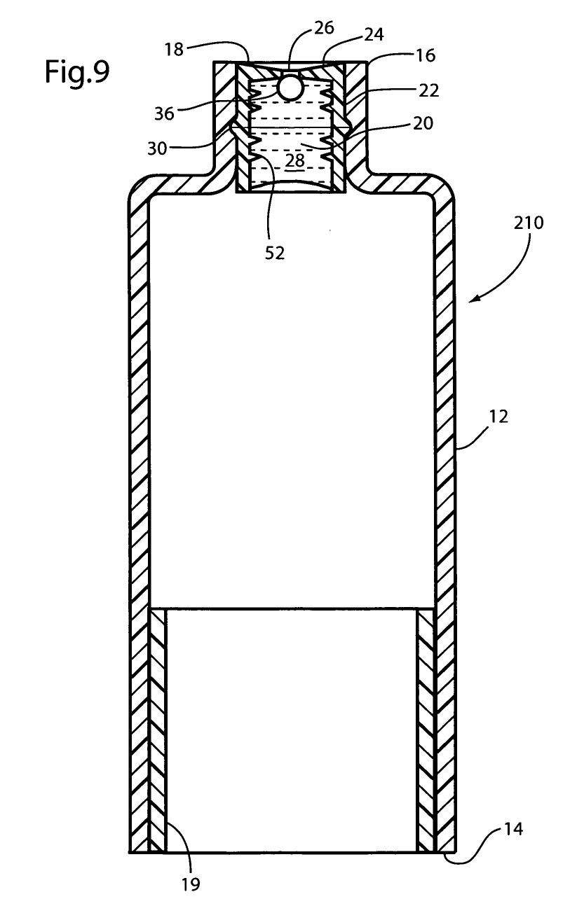

As mentioned above, the interior cavity 20 of end cap 10 is defined by at least the first end wall 24 and the side wall 22 of the plug 18. While the end cap 10 may include a second end wall 32 so as to provide better retention of the self-sealing material 28, the inventors have found that it is not necessary to provide the second end wall 32 in all cases. FIG. 9 illustrates an end cap 210 according to another alternate embodiment of the invention, which is identical to end cap 10 described above except that it includes a plug 18 which comprises only a first end wall 24 and a side wall 22, and does not include a second end wall. The plug 18 defines an interior cavity 22 containing a self-sealing material 28 which may be identical to the self-sealing material 28 of end cap 10. The self-sealing material 28 is usually tacky and adheres to the first end wall 24 and the side wall 22 of plug 18, and is not displaced when perforated by a test probe. Therefore, by choosing a tacky self-sealing material 28 it may be possible to leave the second end of the plug 18 either partly or completely open and thereby eliminate the need for a second end wall. This has the effect of simplifying the construction of the plug 18, so that it can have a one-piece construction. Also, in order to improve retention of the self-sealing material, the inner surface of the plug 218 may be provided with inwardly extending radial projections such as ribs 52 which engage and help to grip the self-sealing material 28. As in the end cap 10, the end cap 210 according to this embodiment of the invention includes a ball 36 which blocks the aperture 26 of the plug 18. However, it will be understood that end cap 210 may instead be provided with an alternate one-way valve member, such as the flap valve 50 of FIGS. 7 and 8, or may not include a one-way valve member at all.

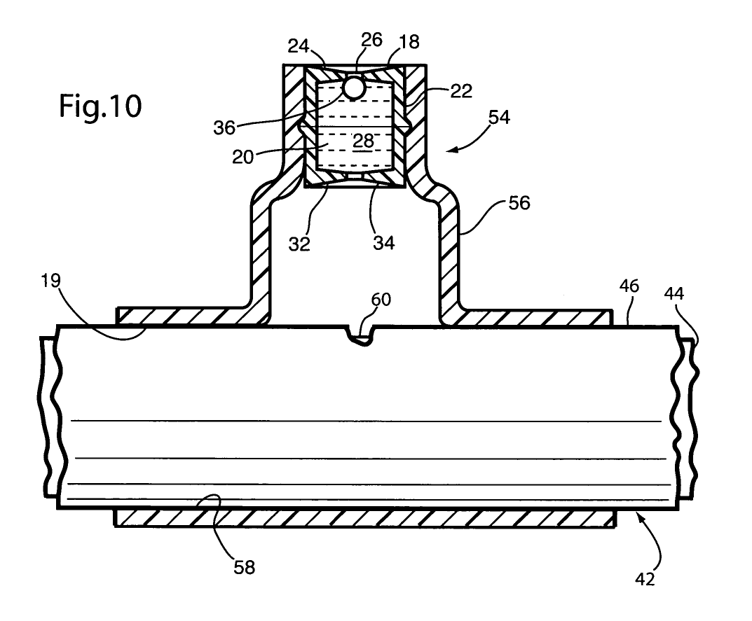

Although specific embodiments described above are all in the form of end caps to cover and seal the exposed end of an electrical cable, it will be appreciated that the present invention includes test terminals which may be secured to the sidewall of the cable jacket so as to permit testing of a cable at any point between its ends. Such an embodiment is now described below with reference to FIG. 10. Shown in FIG. 10 is a test terminal 54 for attachment to the sidewall of a cable 42 comprising a jacket 46 and a conductor 44, as described above. The test terminal 54 includes a sleeve 56 having an open firstend and a second end which is closed by a plug 18, which may be the same as plug 18 described above in connection with the other embodiments described herein. As in the previous embodiments, the sleeve 56 has an inner surface which is bonded to the sidewall 22 of plug 18 so as to provide a water-tight seal. The sleeve 56 may be of the same or similar construction, composition and properties as sleeve 12 of end cap 10 described above. The test terminal 54 also includes a base 58 surrounding the first end of sleeve 56, which forms a flange by which the test terminal 54 is attached to the cable jacket 46. The base 58 is connected to and surrounds the open first end of sleeve 56, and may be comprised of the same or different material as the sleeve 56. The base 58 may be integrally formed with the sleeve 56 and/or may have greater flexibility than sleeve 56 so that it can conform to the outer cylindrical surface of the cable jacket 46. Furthermore, the bottom surface of the base 58 may be provided with a layer of adhesive 60 (which may have the same properties and composition as adhesive 19 described above) to seal it to the cable jacket 46. The base 58 may be configured so as to wrap partially or completely around the cable jacket 46.

The test terminal 54 is used in a similar manner as end cap 10 described above. A test probe (not shown) penetrates through the rigid plug 18 as described above and enters the hollow interior of sleeve 56. The probe then penetrates the cable jacket 46, makes a hole 60 in the jacket 46, and comes into direct electrical contact with the underlying conductor 44. After the test probe 48 is withdrawn, the test terminal 54 forms a water-tight enclosure over the hole 60.

Although the invention has been described in connection with certain embodiments thereof, it is not limited thereto. Rather, the invention includes all embodiments which may fall within the scope of the following claims.

What is claimed is:

1. A resealable test cap, comprising:
a) an outer tubular shell having a first end and a second end, wherein the first end is open;
b) a plug of rigid material closing the second end of the outer shell, wherein the plug has a side wall and a first end wall defining a hollow interior cavity, wherein the first end wall has an aperture extending therethrough to permit access to the interior cavity through the first end wall; and
c) a deformable self-sealing material located inside the interior cavity and sealing the aperture.

2. The resealable test cap according to claim 1, wherein the aperture has a diameter which is less than a maximum diameter of the interior cavity.

3. The resealable test cap according to claim 1, wherein the side wall has a substantially cylindrical outer surface which is sealed to an inner surface of the outer tubular shell.

4. A resealable test cap according to claim 1, wherein the outer surface of the side wall of the plug is provided with one or more circumferentially extending corrugations.

5. The resealable test cap according to claim 1, wherein the outer tubular shell is dimensionally recoverable.

6. The resealable test cap according to claim 5, wherein the second end of the outer tubular shell is dimensionally recovered so as to seal against an outer surface of the side wall of the plug, and such that the second end of the outer tubular shell has a smaller diameter than the first end of the outer tubular shell.

7. A resealable test cap according to claim 1, wherein the rigid plug is comprised of a puncture-resistant polymeric material.

8. The resealable test cap according to claim 1, wherein the first end wall has an outer surface in communication with a surrounding environment of the resealable test cap, and wherein the outer surface of the first end wall comprises an inverted, conical surface with the aperture located at its apex, such that the outer surface of the first end wall forms a guide surface to assist a probe in entering the aperture.

9. The resealable test cap according to claim 1, wherein the plug of rigid material further comprises a second end wall located in opposed relation to the first end wall, and wherein the second end wall has an aperture extending therethrough to permit access to the interior cavity through the second end wall.

10. The resealable test cap according to claim 1, wherein the first end wall has a one-way valve member located inside the cavity, wherein the valve member has a closed configuration in which it is located in blocking relation to the aperture in the first end wall.

11. The resealable test cap according to claim 10, wherein the one-way valve member is displaceable by an object inserted through the aperture into the interior cavity.

12. The resealable test cap according to claim 10, wherein the valve member comprises a flap or a ball.

13. The resealable test cap according to claim 12, wherein the valve member comprises a ball which is embedded in the self-sealing material and has a diameter greater than a diameter of the aperture.

14. The resealable test cap according to claim 13, wherein the first end wall has an inner surface defining an end surface of the interior cavity, wherein the inner surface is in the form of a cone having a base located at the plug side wall and with the aperture located at the apex of the conical surface.

15. The resealable test cap according to claim 1, wherein the plug is comprised of two dish-shaped sections having peripheral flanges along which they are joined together in face-to-face relation.

16. The resealable test cap according to claim 15, wherein the two dish-shaped sections making up the plug are substantially identical mirror images of one another.

17. A resealable test terminal, comprising:
a) an outer tubular sleeve having a first end and a second end, wherein the first end is open;
b) a plug of rigid material closing the second end of the outer shell, wherein the plug has a side wall and a first end wall defining a hollow interior cavity, wherein the first end wall has an aperture extending therethrough to permit access to the interior cavity through the first end wall;
c) a deformable self-sealing material located inside the interior cavity and sealing the aperture; and
d) a flexible flange extending radially outwardly of the first end of the sleeve.
